(19) United States
(12) Patent Application Publication
(10) Pub. No.: US 2003/0098685 A1
(43) Pub. Date: May 29, 2003

(54) Motor speed sensor

(76) Inventor: Harald Edmund Blaettner, Fort Wayne, IN (US)

Correspondence Address: CANTOR COLBURN, LLP, 55 GRIFFIN ROAD SOUTH, BLOOMFIELD, CT, 06002

(21) Appl. No.: 09/683,167

(22) Filed: Nov. 28, 2001

(51) Int. Cl. G01P 3/48

(52) U.S. Cl. 324/174

(57) ABSTRACT

A motor speed sensor and a magnet and hub assembly for increasing the life of a motor speed sensor are disclosed. The motor speed sensor includes an encapsulation solution preserving the connection between Hall device leads sensor leads. The motor speed sensor may include a location tab extending outwardly from a raised periphery of its sensor housing which fits into a recess within a motor end shield. The magnet and hub assembly is securable to an armature shaft of a motor without screws.

### BACKGROUND OF INVENTION

This invention relates generally to a motor. More particularly, this invention relates to an improved design for a motor speed sensor.

Motors for various applications are available which use either AC or DC sources and which use magnets to create motion. Inside an electric motor, the attracting and repelling forces of the magnets create rotational motion. A motor includes an electromagnet, in which the magnetic field only exists when electric current is flowing, and may further include permanent magnets.

The stator of a motor is the non-rotating part of its magnetic structure. In a motor, the stator usually contains the mounting surface, bearing, and non-rotating windings or permanent magnets. The armature and/or the rotor of a motor includes the electromagnet and imparts motion, i.e. rotation, to the motor.

Commutation in motors refers to the action of steering currents or voltage to the proper motor phases so as to produce optimum motor torque. In brush type motors, commutation is done electromechanically via the brushes and commutator. A commutator is a mechanical cylinder consisting of alternating segments of conductive and insulating material. This cylinder used in DC motors passes currents from the brushes into the rotor windings and performs motor commutation as the motor rotates. In brushless motors, commutation is done by the switching electronics using rotor position information typically obtained by Hall sensors, a tachsyn, a resolver, or an encoder. The commutation of the phases in a brushless motor is electronic instead of mechanical as in traditional DC brush type motors. In servo versions, Hall sensors monitor the commutation sequence.

The speed of such motors can be monitored by detecting the frequency of the solid state sensors (Hall sensors) used to capture information about the rotor's position and control the switching of the motor phases.

Referring to FIG. 1, a Hall effect IC 40 (integrated circuit) is a very small chip which includes many transistors. Leads 42 include supply lead 44, ground lead 46, and output lead 48 extending from the branded housing 50. The Hall effect IC 40 consists of a thin layer of silicon as a Hall generator and several transistor circuits to amplify the Hall voltage to a necessary level, to trigger output voltage with its growth, and to provide stable work regardless of the power supply voltage changes. The Hall effect IC or Hall switch is a solid state electronic device with no mechanical parts and therefore it is more reliable than a reed switch, and is thus more commonly used in industrial brushless motors. The Hall switch may include a threaded housing (not shown) surrounding the entire Hall effect IC 40 for simpler mounting and use in harsh environments.

While both motors and Hall sensors have been designed for use in industrial environments, early failure of such sensors within motors have occurred due to installation problems of the sensors within the motor which can result in disconnection and contamination. That is, prior sensors have used a separate plate covering the sensor, and then a plurality of screws to secure the plate to the end shield of the motor. Additionally, false sensor readings have been traced to loose magnet conditions where the attachment of a magnet to the end of the shaft on the motor has a tendency to loosen after usage. That is, prior magnets have typically been screwed onto the end of a shaft, further requiring a washer to be placed between the shaft and magnet. If the screw begins to loosen, the sensor readings may become incorrect.

### SUMMARY OF INVENTION

The above discussed and other drawbacks and deficiencies of the prior art are overcome or alleviated by a motor speed sensor and a magnet and hub assembly. In an exemplary embodiment of the invention, a motor speed sensor includes a Hall device having Hall device leads, sensor leads connected to the Hall device leads, and an encapsulation solution covering the Hall device leads and a portion of the sensor leads.

In another exemplary embodiment of the invention, a magnet and hub assembly includes a ring shaped outer magnet having a portion of its inner periphery removed and a ring shaped inner hub having a portion of its outer periphery removed, wherein the hub lies flushly within the magnet.

In another exemplary embodiment of the invention, the combination of an end shield for a motor and a motor speed sensor includes the motor speed sensor having a sensor housing with a raised periphery and a location tab extending outwardly from the raised periphery. The end shield for a motor in the combination includes a central opening within the end shield, the central opening having a raised periphery interrupted by a first recess. The sensor housing is fitted snugly within the central opening of the end shield with the location tab positioned within the first recess.

In another exemplary embodiment of the invention, a motor includes a speed sensor, an armature shaft, and a magnet and hub assembly secured to the armature shaft without screws.

The above-discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several FIGS.:

FIG. 1 is a plan view of a prior art Hall effect IC;

FIG. 2 is an exploded view of a motor of this invention;

FIG. 3 is a front plan view of a speed sensor for the motor of FIG. 2;

FIG. 4 is a top plan view of a Deutsch receptacle for the speed sensor of FIG. 3;

FIG. 5 is a rear plan view of the speed sensor of FIG. 3;

FIG. 6 is a side cross-sectional view of the speed sensor of FIG. 3 taken along line 6-6 within FIG. 5;

FIG. 7 is a partial side plan view of the speed sensor housing of FIG. 3;

FIG. 8 is a side plan view of the speed sensor housing of FIG. 3;

FIG. 9 is a front plan view of a magnet/hub assembly for the motor of FIG. 2;

FIG. 10 is a side cross-sectional view of the magnet/hub assembly of FIG. 9 taken along line 10-10 within FIG. 9;

FIG. 11 is a partial side cross-sectional view of the magnet/hub assembly of FIG. 10, showing an enlarged detail within FIG. 10;

FIG. 12 is a front plan view of an end shield for the motor of FIG. 2;

FIG. 13 is a side cross-sectional view of the end shield of FIG. 12 taken along line 13-13 within FIG. 12;

FIG. 14 is a rear plan view of the end shield of FIG. 12;

FIG. 15 is a side plan view of the motor of this invention;

FIG. 16 is another side plan view of the motor of this invention;

FIG. 17 is a front plan view of the motor of FIGS. 15-16;

FIG. 18 is a rear plan view of the motor of FIGS. 15-16; and,

FIG. 19 is a cross-sectional view of the front end of the motor of this invention.

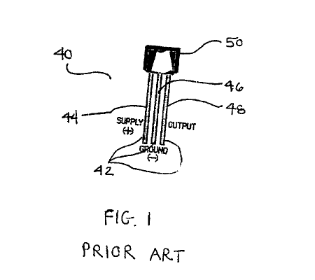

### DETAILED DESCRIPTION

The motor speed sensor of this invention has been designed to address field issues related to contamination of its connections and increased reliability of the connections. Additionally, the magnet on the shaft of the motor has been redesigned to prevent loose magnet conditions thereby reducing the likelihood of false speed signals.

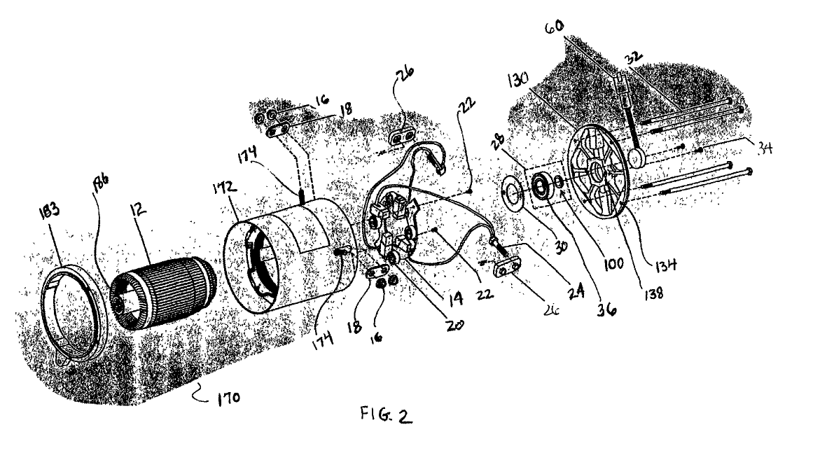

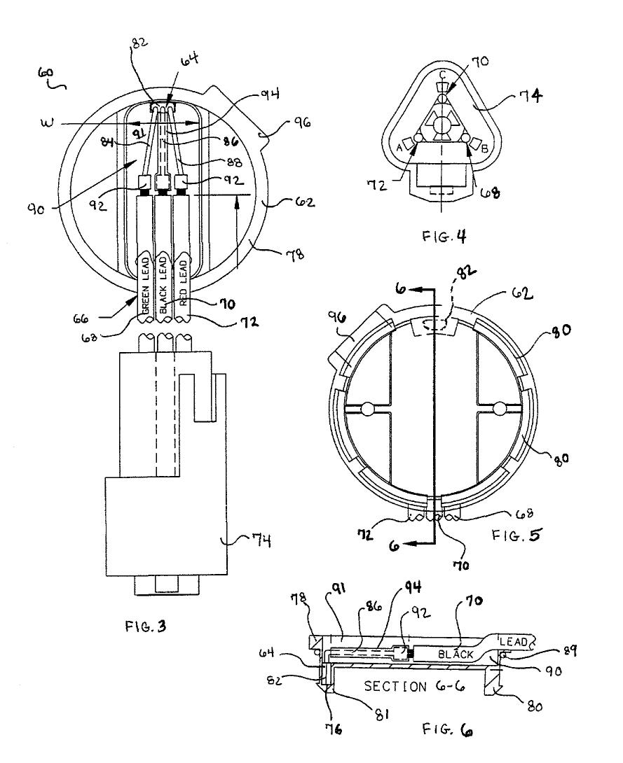

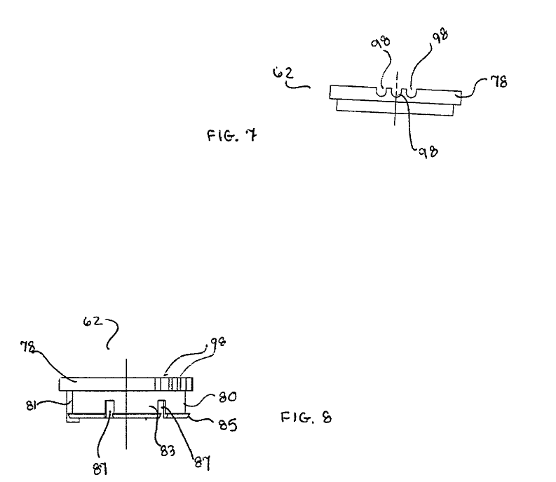

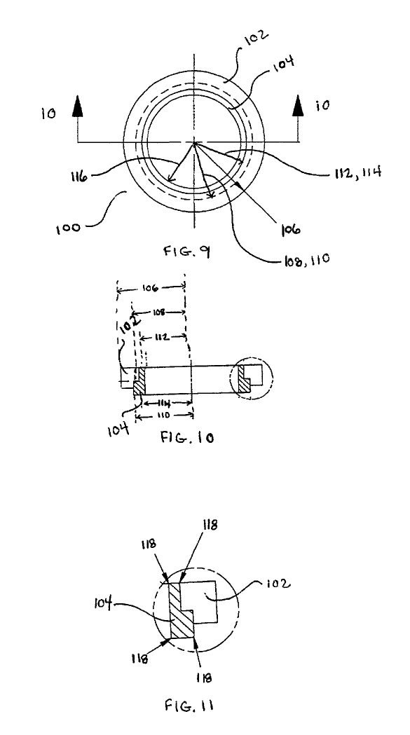

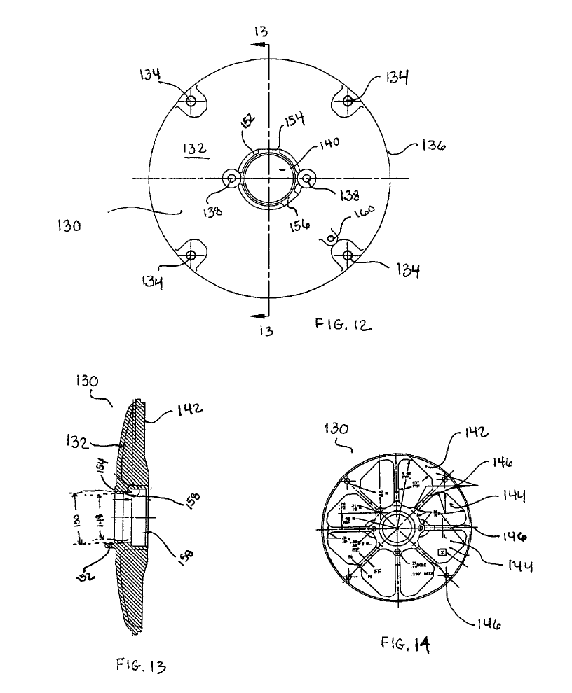

Turning to FIG. 2, an exploded view of the motor 170 is shown. The motor 170 includes a stator shell and winding, that is, housing 172. An end ring 183 is mounted at the rear end of the motor housing 172. Within the housing 172 is the armature 12 and the complete stator including the brush mechanisms 14 and their associated hardware. The brush mechanism 14 includes two pairs of flanged terminal nuts 16 and two insulation bushings 18. One brush mechanism 14 is shown exterior to the housing 172 and the other brush mechanism is shown installed within the housing 172. The brush mechanism includes four springs, shown at 20. The brush mechanism meeting screws 22 are used for installing the brush mechanisms 14 within the housing 172. When fully installed, the two pairs of terminals 174 for the brush kits 24 pass through the insulation bushings 18, the flanged terminal nuts 16, and the insulation bushings 26. Supported on the shaft 186 between the brush mechanism 14 and the end shield 130 is the bearing and magnet kit 28 and the bearing retainer 30. The bearing and magnet kit 28 includes the magnet 100 which will be further described. The end shield 130 covers the front end of the motor 170 and is secured to the front end of the housing 172 using the clamp screws 32. The bearing retainer screws 34 secure the bearing retainer 30 within the assembly. The speed sensor 60, as will be further described, is supported within the end shield 130.

Referring to FIGS. 3-6, a speed sensor 60 is shown. The speed sensor 60 generally includes a speed sensor housing 62, a Hall device 64, and leads 66 as shown in FIG. 3. The leads 66 include green lead 68, black lead 70, and red lead 72, although alternate colors may be employed. The leads 66 extend from the sensor housing 62 to its connection within a Deutsch receptacle housing 74 as shown in FIG. 4.

FIG. 5 shows a rear view of the sensor housing 62, and FIG. 6 shows a side cross-sectional view of the sensor housing 62 taken along line 6-6 within FIG. 5. The housing 82 of the Hall device 64 is shown snugly received within a pocket 76 adjacent the periphery 78 of the sensor housing 62. The pocket 76 extends down into an enclosed tab 81 (see FIG. 8) adjacent the finger tabs 80 which lock the sensor housing 62 into an end shield, as will be further described. Leads 84, 86, and 88 of the Hall device 64 extend from the housing 82 and then bend at an approximately 90 degree angle such that the leads 84, 86, 88 lie substantially flat within a mounting channel 90 within the sensor housing 62. The mounting channel 90 includes a width w and extends the inner diameter of the sensor housing 62 within the raised periphery 78. Lead 84 then connects to green lead 68, lead 86 connects to black lead 70, and lead 88 connects to red lead 72, all through connections 92. As shown with lead 86 and black lead 70, the connection to the Hall device lead 86 may be protected by a covering 94. Additionally, after the leads 66 and the Hall device 64 are connected and positioned within the sensor housing 62, an encapsulation solution 91 (i.e. a potting compound, such as Biwax 639 by Loctite, or any other material providing good flow and good adhesion) is poured into the mounting channel 90 to affix the assembly of the Hall device 64 and leads 66 within the sensor housing 62 after curing.

The life of a speed sensor, its ability to provide a digital signal proportional to armature speed to the motor controller, has previously been limited due to early failure because of shorted connections (and thus loss of output signal). This defect is related to induced manufacturing defects, improper cleaning of solder flux from the circuit board locating the hall device leads, aggravated by proximity of the mounting holes (pads) on the circuit boards. This invention assures spacing at the connection points of the Hall device leads 84, 86, 88 to harness the leads 66, thus ensuring spacing of stripped portion of leads 66 and including the connections 92. Spacing and attachment is additionally enhanced by the fact that the mounting channel 90 in which the leads 84, 86, 88 are positioned is filled with an encapsulation 91. Thus, the new design eliminates contamination of the connections as well as maintains the connections intact.

The speed sensor housing 62 further includes a location tab 96 which helps prevent the incorrect installation of the housing 62 into the end shield as will be discussed and which allows removal of the housing from the end shield using a regular screw driver. The particular embodiment of the location tab 96 shown is slightly offset from the mounting channel 90, and extends from the outer diameter of the raised periphery 78.

Turning now to FIG. 7, a portion of the speed sensor housing 62 is shown. The raised periphery 78 of the housing 62 is shown to include U-shaped indents 98 for receiving and spacing apart the exiting leads 66 from the housing 62. FIG. 8 shows the speed sensor housing 62 with the lead receiving indents 98, the finger tabs 80, and the Hall device housing receiving tab 81. The finger tabs 80 include a rounded outer cylindrical portion 83 and a triangular shaped protrusion 85 at the bottom of each tab 80. The finger tabs 80 are spaced apart by spaces 87 which allow for the slight compression inward of the finger tabs 80 when the housing 62 is pushed into an end shield. When the housing 62 is inserted into an end shield, as will be further discussed below, an O-ring 89 (as shown in FIG. 6) may surround the rounded outer cylindrical portion 83 just below the raised periphery 78 to compensate for the differential thermal expansion between the end shield and the sensor housing 62, and provide a seal against water and dust.

Turning now to FIGS. 9-11, another aspect which affects the life of a motor speed sensor is revised. In previous designs, the magnet ring is attached to the end of the shaft of the motor using a screw to hold the magnet against the face of the end of the shaft. The screw has had a tendency to loosen after some usage resulting in false speed signals or even magnet failure. The expensive hole in the shaft for receiving the screw has been replaced by a press-fit between magnet hub and shaft outer diameter near the bearing. No special consideration for tolerance has to be made since the bearing surface is already at a low value (required for bearing use). The magnet/hub assembly 100 is shown in FIGS. 9-11. The magnet/hub assembly 100 includes a magnet ring 102 attached to the hub 104. The magnet ring 102 has an outer radius 106 which equals the outer radius of the magnet/hub assembly 100. The magnet ring 102 also has a first inner radius 108 which approximately equals the first outer radius 110 of the hub 104. The magnet ring 102 also has a second inner radius 112, smaller than the first inner radius 108, and approximately equal to the second outer radius 114 of the hub 104. The hub 104 also includes an inner radius 116 which forms the inner radius of the magnet/hub assembly 100. Thus, the magnet ring 102 includes a small portion of its ring removed from its inner radius and the hub 104 includes a small portion of its hub removed from its outer diameter such that the magnet ring 102 and the hub 104 are complimentarily fitted together. As shown in FIG. 11, the hub 104 may be chamfered at points 118. Preferably, the magnet ring 102 is a molded ceramic ferrite magnet and the hub 104 is steel. Also, the magnet ring 102 is preferably adhesively attached to the hub 104. After assembling the magnet/hub assembly 100, it may be pressed over an armature shaft of a motor, as will be further shown in FIG. 19.

FIGS. 12-14 show views of an end shield 130 for receiving the speed sensor housing 62. FIG. 12 shows the front surface 132 of the end shield 130, while FIG. 14 shows the rear surface 142. The rear surface may include cutouts 144 separated by ribs 146 for reducing the amount of material needed for the end shield 130. The end shield 130 includes screw holes 134 near the periphery 136, its outer diameter, of the end shield 130. The end shield 130 may also include an additional pair of screw holes 138 near its inner diameter. A central opening 140 within the end shield 130 is designed for accepting the speed sensor 60. The central opening 140 includes an inner diameter 148 for receiving the rounded outer cylindrical portion 83 of the sensor housing 62 and a slightly larger inner diameter 150 for receiving the triangular shaped protrusions 85 of the finger tabs 80. The sensor housing 62 is thus designed to allow the finger tabs 80 to lock into the central opening 140 in the end shield 130. The finger tabs 80 are designed to compress upon insertion of the housing 62 into the end shield 130 and spring back to lock the housing 62 into the end shield 130. That is, the triangular shaped protrusions 85 abut against the step 158 created between the inner diameter 148 and the inner diameter 150.

The central opening 140 further includes a raised periphery 152 interrupted by a first recess 154 sized to accept the location tab 96 of the sensor housing 62. The first recess 154 serves the function of preventing incorrect sensor orientation at the time of installation. The location tab 96 on the sensor housing 62 only fits into the housing at the 12:00 location shown and protects the speed sensor 60 from damage during motor handling. A second recess 156 is dimensioned within the raised periphery 152 of the central opening 140 for receiving the exiting leads 66 of the speed sensor 60. Location 160 upon the front surface 132 of the end shield 130 may be used to clamp down the exiting leads 66 as will be shown.

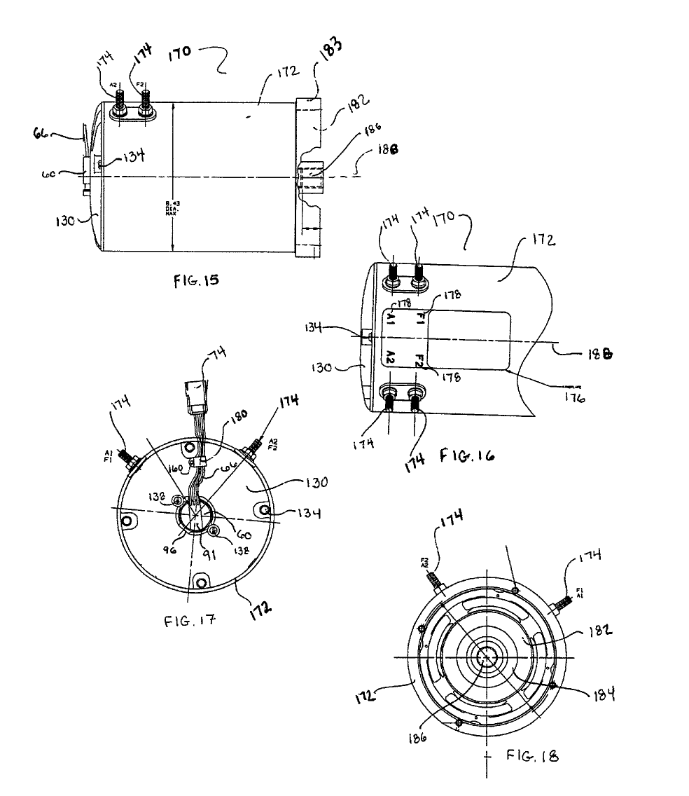

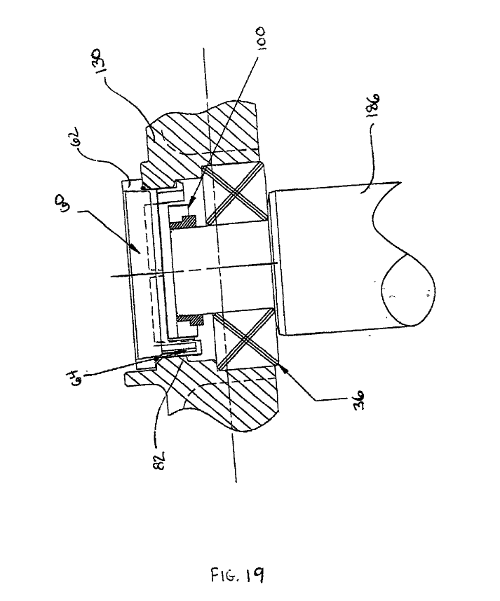

FIGS. 15-19 show different views of an assembled motor 170 using the speed sensor 60 of this invention. Referring to FIGS. 15-16, the motor 170 includes a housing 172 of a generally cylindrical construction surrounding internal elements of the motor 170 including the magnet/hub assembly 100, as shown in FIG. 19. Electrical terminals 174 exit from the housing 172 for the brush kits 24 of the motor 170. A nameplate 176 may be provided on the housing 172 and may include labels 178 for identifying the terminals 174. Referring to FIG. 17, the end shield 130 is shown secured to the housing 172 via screws 32 (shown in FIG. 2) provided through the screw holes 134. The speed sensor 60 is shown secured within the end shield 130 with the leads 66 exiting the sensor housing 62 through the second recess 156 and clamped down to the end shield 130 via clamp 180 provided at location 160. The Hall device 64 including its leads 84, 86, 88 are not visible in FIG. 17 because they are covered with the potting compound 91 within the mounting channel 90.

Referring to FIG. 18, a rear view of the motor 170 is shown which depicts an adapter face 184 of an adapter 182 through which exits a shaft 186 which lies along the longitudinal axis 188 of the motor 170. The shaft 186 may include the cross-sectional shape of an involute spline as shown.

Referring to FIG. 19, it can be seen that the magnet/hub assembly 100 is pressed flush to the end of the shaft 186, which has a reduced diameter portion within the end shield 130. It should also be noted that the magnet/hub assembly 100 is positioned within the end shield 130 and adjacent the sensor housing 62 of the speed sensor 60. The housing 82, which contains the transducer, of the Hall device 64 is thus adjacent the magnet/hub assembly 100 as shown.

In use, the motor 170 may be mounted to a gear housing of a vehicle through the adapter 182 and end ring 183. The motor 170 may be connected to a transmission shaft via the shaft 186. The speed sensor 60 prevents the vehicle, such as a golf cart, from excessive speeds down hill and ensures the most efficient operation of the motor 170 during usage.

The design of the speed sensor 60 and magnet/hub assembly 100 reduces the cost of the speed sensor for a motor by reducing material cost and assembly time, while reducing the defects that resulted from previous designs.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A motor speed sensor comprising:
a Hall device having Hall device leads;
sensor leads connected to the Hall device leads; and,
an encapsulation solution covering the Hall device leads and a portion of the sensor leads.

2. The motor speed sensor of claim 1 further comprising:
a sensor housing, the Hall device positioned within the sensor housing, the sensor housing including a mounting channel for receiving the Hall device leads, a portion of the sensor leads, and the encapsulation solution.

3. The motor speed sensor of claim 2 wherein the housing includes a raised periphery, recesses in the raised periphery for passing sensor leads exiting the speed sensor, a location tab extending outwardly from the raised periphery, the sensor housing further including a pocket for receiving a Hall device housing, the Hall device leads extending perpendicularly to the Hall device housing, the sensor housing further including compressible finger tabs on a rear surface of the sensor housing.

4. The motor speed sensor of claim 2 wherein the sensor housing includes compressible finger tabs for locking the sensor housing into an end shield of a motor.

5. The motor speed sensor of claim 4 wherein the finger tabs include a rounded outer cylindrical portion positioned on a rear surface of the sensor housing and a triangular shaped protrusion at a base of each finger tab.

6. The motor speed sensor of claim 2 wherein the housing includes a periphery and a location tab extending outwardly from the periphery.

7. The motor speed sensor of claim 2 wherein the Hall device includes a Hall device housing positioned within a pocket of the sensor housing.

8. The motor speed sensor of claim 7 wherein the Hall device leads extend perpendicular to the Hall device housing.

9. The motor speed sensor of claim 2 wherein the housing includes a raised periphery, and recesses in the raised periphery for passing sensor leads exiting the speed sensor.

10. The motor speed sensor of claim 1 wherein the encapsulation solution is a potting compound.

11. A magnet and hub assembly comprising:
a ring shaped outer magnet having a portion of its inner periphery removed; and,
a ring shaped inner hub having a portion of its outer periphery removed;
wherein the hub lies flushly within the magnet.

12. The magnet and hub assembly of claim 11 wherein outer edges of the hub are chamfered.

13. The magnet and hub assembly of claim 11 wherein the magnet is adhesively secured to the hub.

14. The magnet and hub assembly of claim 11 wherein the magnet is a molded ceramic ferrite magnet and the hub is a steel hub.

15. The magnet and hub assembly of claim 11 wherein the magnet has an outer radius equal to an outer radius of the magnet and hub assembly, a first inner radius of the magnet substantially equal to a first outer radius of the hub, a second inner radius of the magnet substantially equal to a second outer radius of the hub, and an inner radius of the hub equal to an inner radius of the magnet and hub assembly.

16. The magnet and hub assembly of claim 15 wherein the first inner radius of the magnet is greater than the second inner radius of the magnet.

17. In combination, an end shield for a motor and a motor speed sensor, the motor speed sensor comprising:
a sensor housing having a raised periphery; and,
a location tab extending outwardly from the raised periphery;
the end shield for a motor comprising:
a central opening within the end shield, the central opening having a raised periphery interrupted by a first recess;
wherein the sensor housing is fitted snugly within the central opening with the location tab positioned within the first recess.

18. The combination of claim 17 further comprising a Hall device positioned in the sensor housing and having Hall device leads; and sensor leads connected to the Hall device leads.

19. The combination of claim 18 wherein the sensor housing includes a mounting channel, the mounting channel filled with an encapsulation solution covering the Hall device leads and a portion of the sensor leads.

20. The combination of claim 18 wherein the raised periphery of the central opening is interrupted by a second recess, the sensor leads exiting the sensor housing through the second recess.

21. The combination of claim 20 wherein the end shield includes a clamp, the clamp securing the sensor leads to the end shield.

22. The combination of claim 20 wherein the raised periphery of the sensory housing includes indents, each sensor lead supported within one indent.

23. The combination of claim 17 wherein the sensor housing includes compressible finger tabs locking the sensor housing into the end shield.

24. The combination of claim 23 wherein the finger tabs include a rounded outer cylindrical portion positioned on a rear surface of the sensor housing and a triangular shaped protrusion at a base of each finger tab, the end shield having a first inner diameter receiving the outer cylindrical portion and a second inner diameter, larger than the first inner diameter, receiving the triangular shaped protrusion of each finger tab.

25. A motor comprising:
a speed sensor;
an armature shaft; and,
a magnet secured to the armature shaft without screws.

26. The motor of claim 25 wherein the speed sensor includes a Hall device having Hall device leads and sensor leads connected to the Hall device leads, the speed sensor further comprising an encapsulating solution surrounding the Hall device leads and a portion of the sensor leads.

27. The motor of claim 25 wherein the magnet is part of a magnet and hub assembly including:
a ring shaped outer magnet having a portion of its inner periphery removed; and,
a ring shaped inner hub having a portion of its outer periphery removed;
wherein the hub lies flushly within the magnet.

28. The motor of claim 25 wherein the speed sensor has a sensor housing with a raised periphery and a location tab extending outwardly from the raised periphery, the motor further comprising an end shield, the end shield comprising a central opening within the end shield, the central opening having a raised periphery interrupted by a recess, wherein the sensor housing is fitted snugly within the central opening with the location tab positioned within the recess.

29. The motor of claim 25 wherein the magnet is part of a ring-shaped magnet and hub assembly pressed over a reduced diameter portion of the armature shaft to lie flush with an end of the armature shaft.
